(19) United States
(12) Patent Application Publication
(10) Pub. No.: US 2026/0369947 A1
(43) Pub. Date: Nov. 19, 2026

(54) METHOD OF MANUFACTURING TERMINAL

(71) Applicant: Yazaki Corporation, Tokyo (JP)

(72) Inventors: Masato YAMAGISHI, Shizuoka (JP); Tsukasa MATSUDAIRA, Shizuoka (JP); Harunori TASHIRO, Shizuoka (JP); Kazuhiro IZUMO, Shizuoka (JP)

(73) Assignee: Yazaki Corporation, tokyo (JP)

(21) Appl. No.: 19/653,681

(22) Filed: Apr. 21, 2026

(30) Foreign Application Priority Data
May 13, 2025 (JP) 2025-080541

(51) Int. Cl. H01R 43/16; H01R 43/048

(52) U.S. Cl. CPC H01R 43/16; H01R 43/048

(57) ABSTRACT

A method of manufacturing a terminal includes a bending process of bending a pair of second rectangular plate portions inward in a width direction in a stepwise manner, a compression process of compressing the pair of second rectangular plate portions and a first rectangular plate portion to form an electric connection portion having a solid structure, and a distal end shape forming process of forming a distal end portion of the electric connection portion into a hemispherical shape. The bending process includes at least a bending the second rectangular plate portion along the width direction, a inserting at least a part of the second rectangular plate portion between both end portions of the first rectangular plate portion in the width direction, and a bending the first rectangular plate portion so that both the end portions of the first rectangular plate portion in the width direction approach each other.

### CROSS-REFERENCE TO RELATED APPLICATIONS

The present application is based on, and claims priority from the prior Japanese Patent Application No. 2025-080541, filed on May 13, 2025, the entire contents of which are incorporated herein by reference.

### TECHNICAL FIELD

The present disclosure relates to a method of manufacturing a terminal.

### BACKGROUND

In order to charge a battery mounted on a vehicle such as an electric vehicle and a hybrid vehicle, a charging inlet into which a charging connector as a mating connector is fitted is provided in the vehicle. A terminal (solid terminal), which is a component of this type of charging inlet, is manufactured, for example, by forging and machining. However, in recent years, for the purpose of reducing manufacturing cost, a technique has been proposed in which a terminal base material is formed by punching a metal plate material, and a solid terminal is manufactured by subjecting the terminal base material to press working (see JP 2024-80202 A).

### SUMMARY OF THE INVENTION

In the technique disclosed in JP 2024-80202 A, since the terminal base material formed to be elongated in a front-rear direction is bent in the front-rear direction to manufacture an electric connection portion having a solid structure, the material yield of the terminal base material is poor, and manufacturing cost may be increased due to an increase in material cost. Further, since there are ten bending processes for bending the terminal base material formed by punching the metal plate material, and a die is required in each of the bending processes, manufacturing cost may be increased due to an increase in die cost.

An object of the present disclosure is to provide a method of manufacturing a terminal that achieves manufacturing cost reduction by improving yield and reducing the number of manufacturing processes.

A method of manufacturing a terminal according to an embodiment is a method of manufacturing a terminal including an electric connection portion having a solid structure to which a mating terminal is electrically connected, the method including a punching process of subjecting a metal plate material to punching to form a terminal base material including a first rectangular plate portion having a rectangular plate shape and a pair of second rectangular plate portions each having a rectangular plate shape and being arranged on both sides of the first rectangular plate portion in a short-side direction thereof; a bending process of bending the first rectangular plate portion so as to protrude outward in a plate thickness direction of the terminal base material and, at the same time, bending the pair of second rectangular plate portions inward in the short-side direction in a stepwise manner; a compression process of compressing, in an intersecting direction intersecting with a longitudinal direction, the pair of second rectangular plate portions bent inward in the short-side direction and the first rectangular plate portion to form the electric connection portion having a solid structure; and a distal end shape forming process of forming a distal end portion of the electric connection portion having a solid structure into a hemispherical shape, wherein the bending process includes at least: a bending the second rectangular plate portion along the short-side direction while bending the pair of second rectangular plate portions in a stepwise manner; a inserting at least a part of the second rectangular plate portion bent along the short-side direction between both end portions of the first rectangular plate portion in the short-side direction; and a bending the first rectangular plate portion so that both the end portions of the first rectangular plate portion in the short-side direction approach each other.

According to the above-mentioned configuration, it is possible to provide a method of manufacturing a terminal that achieves manufacturing cost reduction by improving yield and reducing the number of manufacturing processes.

### BRIEF DESCRIPTION OF DRAWINGS

FIG. 1 is a perspective view illustrating an example of a terminal according to the present embodiment.

FIG. 2A is a perspective view of a terminal base material formed in a punching process using a die.

FIG. 2B is a plan view of the terminal base material formed in the punching process using the die.

FIG. 2C is a side view of the terminal base material formed in the punching process using the die.

FIG. 2D is a front view of the terminal base material formed in the punching process using the die.

FIG. 2E is a schematic perspective view of the die used in the punching process.

FIG. 3A is a perspective view of the terminal base material subjected to press working in a first bending process using a die.

FIG. 3B is a plan view of the terminal base material subjected to press working in the first bending process using the die.

FIG. 3C is a side view of the terminal base material subjected to press working in the first bending process using the die.

FIG. 3D is a front view of the terminal base material subjected to press working in the first bending process using the die.

FIG. 3E is a schematic perspective view of the die used in the first bending process.

FIG. 4A is a perspective view of the terminal base material subjected to press working in a second bending process using a die.

FIG. 4B is a plan view of the terminal base material subjected to press working in the second bending process using the die.

FIG. 4C is a side view of the terminal base material subjected to press working in the second bending process using the die.

FIG. 4D is a front view of the terminal base material subjected to press working in the second bending process using the die.

FIG. 4E is a schematic perspective view of the die used in the second bending process.

FIG. 5A is a perspective view of the terminal base material subjected to press working in a third bending process using a die.

FIG. 5B is a plan view of the terminal base material subjected to press working in the third bending process using the die.

FIG. 5C is a side view of the terminal base material subjected to press working in the third bending process using the die.

FIG. 5D is a front view of the terminal base material subjected to press working in the third bending process using the die.

FIG. 5E is a schematic perspective view of the die used in the third bending process.

FIG. 6A is a perspective view of the terminal base material subjected to press working in a fourth bending process using a die.

FIG. 6B is a plan view of the terminal base material subjected to press working in the fourth bending process using the die.

FIG. 6C is a side view of the terminal base material subjected to press working in the fourth bending process using the die.

FIG. 6D is a front view of the terminal base material subjected to press working in the fourth bending process using the die.

FIG. 6E is a schematic perspective view of the die used in the fourth bending process.

FIG. 7A is a perspective view of the terminal base material subjected to press working in a fifth bending process using a die.

FIG. 7B is a plan view of the terminal base material subjected to press working in the fifth bending process using the die.

FIG. 7C is a side view of the terminal base material subjected to press working in the fifth bending process using the die.

FIG. 7D is a front view of the terminal base material subjected to press working in the fifth bending process using the die.

FIG. 7E is a schematic perspective view of the die used in the fifth bending process.

FIG. 8A is a perspective view of the terminal base material subjected to press working in a sixth bending process using a die.

FIG. 8B is a plan view of the terminal base material subjected to press working in the sixth bending process using the die.

FIG. 8C is a side view of the terminal base material subjected to press working in the sixth bending process using the die.

FIG. 8D is a front view of the terminal base material subjected to press working in the sixth bending process using the die.

FIG. 9A is a perspective view of the terminal base material press-formed in a compression process.

FIG. 9B is a plan view of the terminal base material press-formed in the compression process.

FIG. 9C is a side view of the terminal base material press-formed in the compression process.

FIG. 9D is a front view of the terminal base material press-formed in the compression process.

FIG. 10A is a perspective view of the terminal base material press-formed in a distal end shape forming process.

FIG. 10B is a plan view of the terminal base material press-formed in the distal end shape forming process.

FIG. 10C is a side view of the terminal base material press-formed in the distal end shape forming process.

FIG. 10D is a front view of the terminal base material press-formed in the distal end shape forming process.

FIG. 11A is a schematic cross-sectional view of the die used in the first bending process.

FIG. 11B is a schematic cross-sectional view of the die used in the second bending process.

FIG. 11C is a schematic cross-sectional view of the die used in the third bending process.

FIG. 11D is a schematic cross-sectional view of the die used in the fourth bending process.

FIG. 11E is a schematic cross-sectional view of the die used in the fifth bending process.

### DETAILED DESCRIPTION OF THE INVENTION

With reference to the drawings, a method of manufacturing a terminal according to the present embodiment is described below in detail. Note that the dimensional ratios in the drawings are exaggerated for explanatory purposes, and may differ from the actual ratios.

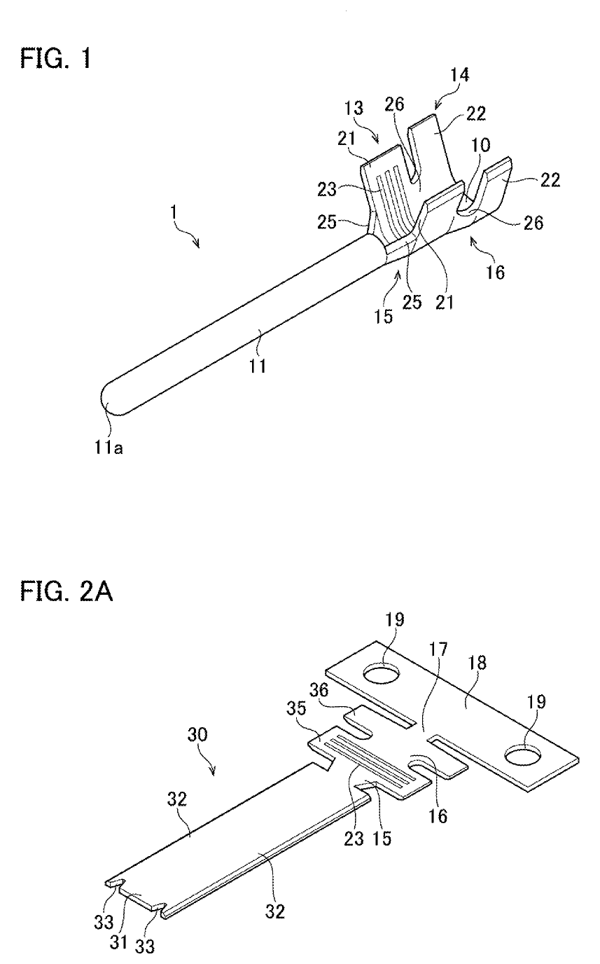

As illustrated in FIG. 1, a terminal 1 is a terminal (solid terminal) that is connected to an electric wire (omitted in illustration) by pressure-connection. The terminal 1 includes a bottom plate 10 (a plate-shaped terminal main body) formed of a metal material such as copper and aluminum. An electric connection portion 11 having a solid structure, a conductor crimping portion 13, and an insulator crimping portion 14 are formed from one end side to the other end side of the bottom plate 10 in a front-rear direction of the terminal 1 or in an extending direction of the electric wire to which the terminal 1 is pressure-connected.

Further, a first joining portion 15 that joins the electric connection portion 11 and the conductor crimping portion 13 is formed between the electric connection portion 11 and the conductor crimping portion 13. Further, a second joining portion 16 that joins the conductor crimping portion 13 and the insulator crimping portion 14 is formed between the conductor crimping portion 13 and the insulator crimping portion 14.

The electric connection portion 11 is a portion that is connected to a mating terminal of another component (omitted in illustration). The electric connection portion 11 is formed to have a solid structure.

The conductor crimping portion 13 is a portion that is crimped and pressure-connected to a conductor of the electric wire to which the terminal 1 is pressure-connected. On the other hand, the insulator crimping portion 14 is a portion that is crimped and pressure-connected to an insulator of the electric wire to which the terminal 1 is pressure-connected.

In other words, at the position of the conductor crimping portion 13 of the bottom plate 10, a pair of conductor crimping piece portions 21 that are crimped and pressure-connected to the conductor of the electric wire are formed so as to protrude outward. The pair of conductor crimping piece portions 21 extend from both side edges of the bottom plate 10 in a direction intersecting with the extending direction of the electric wire. Before being pressure-connected to the electric wire, the bottom plate 10 and the pair of conductor crimping piece portions 21 are formed in a substantially U-shape as viewed from the extending direction of the electric wire. Further, at the position of the conductor crimping portion 13 of the bottom plate 10, serrations 23 are formed so as to extend in a groove shape across the bottom plate 10 and the pair of conductor crimping piece portions 21 along a direction intersecting the extending direction of the electric wire. In the present embodiment, three serrations 23 are formed side by side in the extending direction of the electric wire that is to be pressure-connected at the conductor crimping portion 13.

On the other hand, at the position of the insulator crimping portion 14 of the bottom plate 10, a pair of insulator crimping piece portions 22 that are pressure-connected to the insulator of the electric wire are formed so as to protrude outward. The pair of insulator crimping piece portions 22 extend from both the side edges of the bottom plate 10 in the direction intersecting with the extending direction of the electric wire. Before being pressure-connected to the electric wire, the bottom plate 10 and the pair of insulator crimping piece portions 22 are formed in a substantially U-shape as viewed from the extending direction of the electric wire.

Further, the first joining portion 15 is configured to include the bottom plate 10 and a pair of first side plates 25, and the first side plates 25 join the rear end edge of the electric connection portion 11 and the front end edge of the conductor crimping piece portion 21. On the other hand, the second joining portion 16 is configured to include the bottom plate 10 and a pair of second side plates 26, and the second side plates 26 join the rear end edge of the conductor crimping piece portion 21 and the front end edge of the insulator crimping piece portion 22.

The terminal 1 is electrically connected to the mating terminal (omitted in illustration) or the like in a state of being integrally connected with the electric wire. Although omitted in illustration, the electric wire to be pressure-connected has its insulator removed at its end portion so that the conductor is exposed by a predetermined length. The conductor is, for example, an aggregate of a plurality of element wires. The conductor is formed of a conductive metal material such as copper and aluminum, and the insulator is formed of an insulating covering material. The terminal 1 is electrically connected to the exposed conductor by being pressure-connected to the end portion of the electric wire.

An example of a method of manufacturing the terminal 1 is described below.

The method of manufacturing the terminal 1 according to the present embodiment includes at least a punching process, a bending process, a compression process, and a distal end shape forming process.

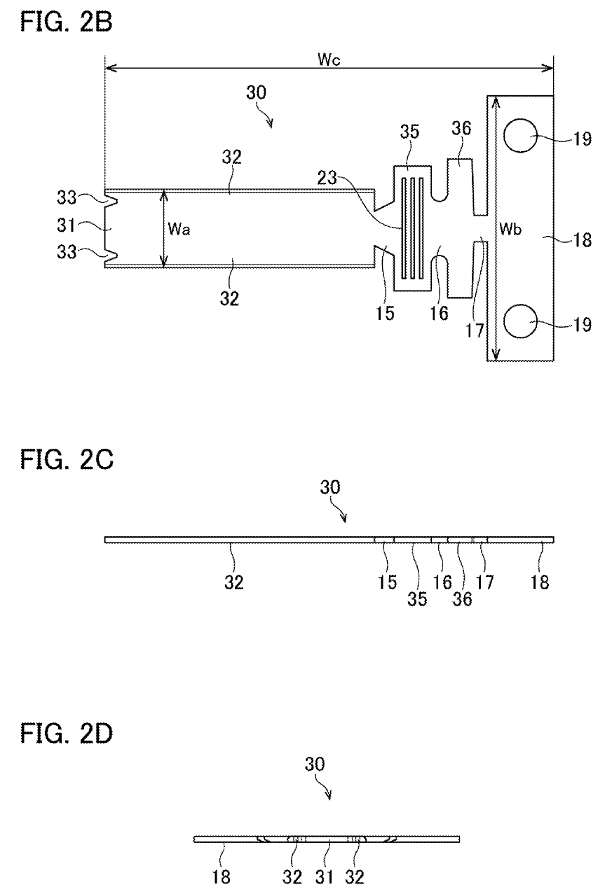

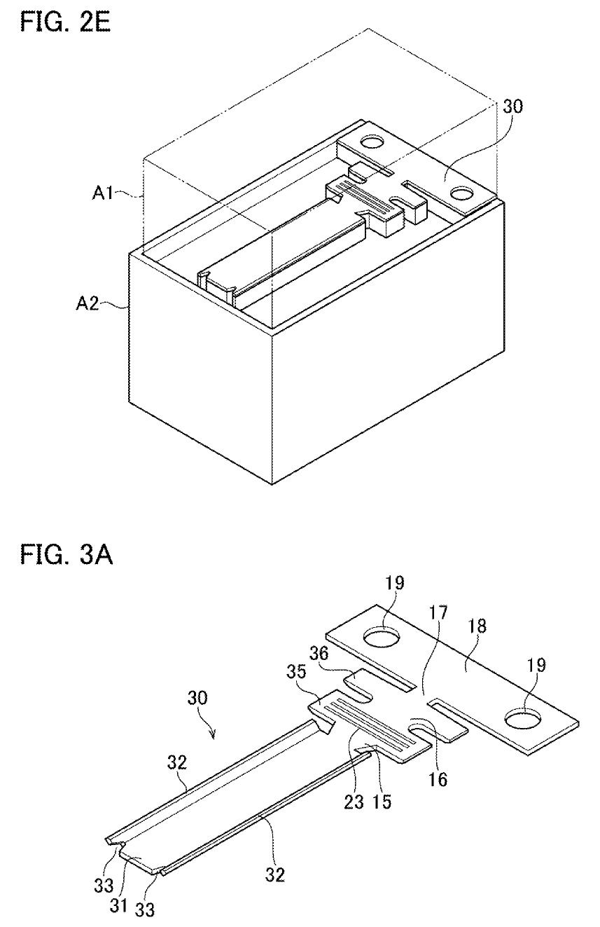

First, with reference to FIGS. 2A-2E, the punching process is described.

The punching process is a process of subjecting a metal plate material to punching to form a terminal base material 30 including a first rectangular plate portion 31 having a rectangular plate shape and a pair of second rectangular plate portions 32 each having a rectangular plate shape and being arranged on both sides of the first rectangular plate portion 31 in a width direction thereof. In the punching process, the terminal base material 30 including at least the first rectangular plate portion 31 and the pair of second rectangular plate portions 32 are formed using dies A1 and A2. The first rectangular plate portion 31 forms a cylindrical outer shell portion on an outer peripheral side of the electric connection portion 11 having a solid structure, and the pair of second rectangular plate portions 32 form a solid portion on an inner peripheral side of the electric connection portion 11 having a solid structure.

In the present embodiment, a width (a lateral width Wa) of the first rectangular plate portion 31 including the pair of second rectangular plate portions 32 in a short-side direction is smaller than a width (a lateral width Wb) of a link portion 18 having a band plate shape, which is described later (see FIG. 2B). The pair of second rectangular plate portions 32 forming the solid portion on the inner peripheral side of the electric connection portion 11 are formed on both sides of the first rectangular plate portion 31, which forms the outer shell portion on the outer peripheral side of the electric connection portion 11, in the width direction. With this, a vertical width Wc of the terminal base material 30 (see FIG. 2B) can be smaller than that in the related art. In other words, the lateral width Wa of the first rectangular plate portion 31 including the pair of second rectangular plate portions 32 can be increased more than that in the related art within a range smaller than the lateral width Wb of the link portion 18 having a band plate shape, and consequently, the material yield of the terminal base material 30 can be improved. The terminal base material 30 (the metal plate material) is formed of a metal material such as copper and aluminum.

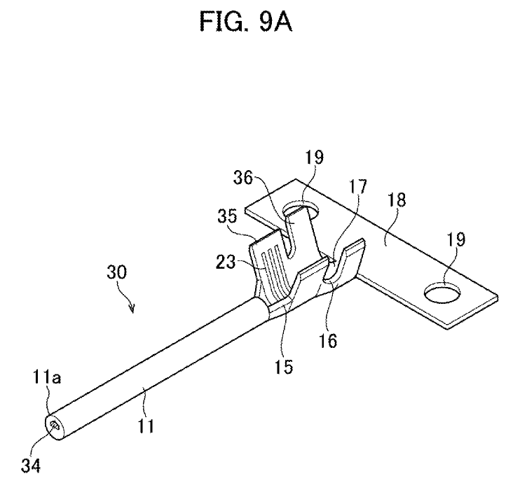

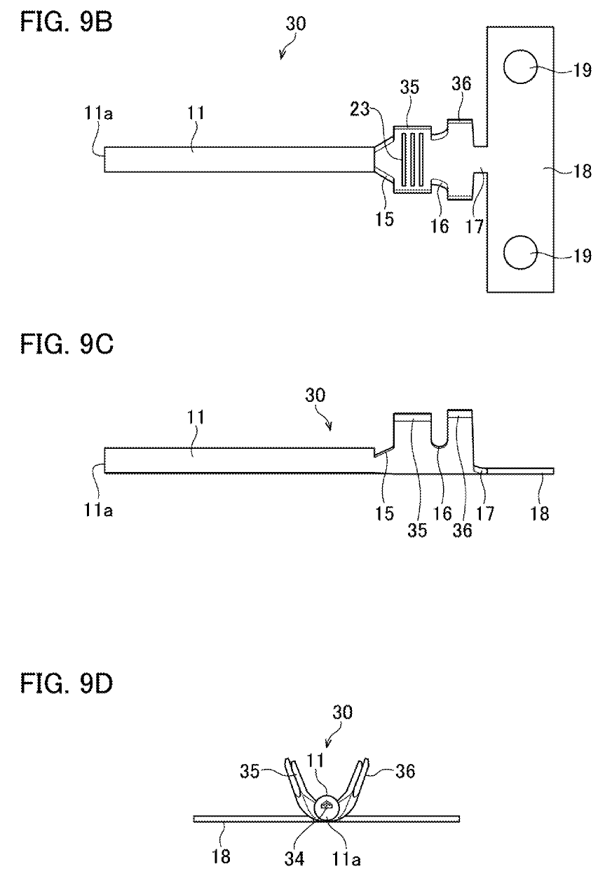

Further, a pair of slit portions 33 are formed in the short-side direction (the width direction) at the distal end portion of the terminal base material 30 in the punching process using the dies A1 and A2 so that a distal end portion 11a of the electric connection portion 11 is formed into a hemispherical shape in the distal end shape forming process, which is described later. By forming the slit portion 33 at the distal end portion of the terminal base material 30 between the first rectangular plate portion 31 and the second rectangular plate portion 32, it is easier to form a gap 34 (see FIG. 9A) near the distal end of the electric connection portion 11 having a solid structure and form the distal end portion 11a of the electric connection portion 11 into a hemispherical shape.

Further, a third rectangular plate portion 35 that has a rectangular plate shape and the first joining portion 15 that joins the first rectangular plate portion 31 and the third rectangular plate portion 35 are formed on the terminal base material 30 in the punching process using the dies A1 and A2. Further, a fourth rectangular plate portion 36 that has a rectangular plate shape and the second joining portion 16 that joins the third rectangular plate portion 35 and the fourth rectangular plate portion 36 are formed on the terminal base material 30 in the punching process using the dies A1 and A2. The third rectangular plate portion 35 forms the conductor crimping portion 13 at the terminal 1, and the fourth rectangular plate portion 36 forms the insulator crimping portion 14 at the terminal 1.

Moreover, the link portion 18 that has a band plate shape and a third joining portion 17 that joins the fourth rectangular plate portion 36 (the insulator crimping portion 14) and the link portion 18 are formed on the terminal base material 30 in the punching process using the dies A1 and A2. In the punching process, two pilot holes (small holes 19) may be formed in the link portion 18.

Next, the bending process is described.

The bending process is a process of bending the first rectangular plate portion 31 so as to protrude outward in a plate thickness direction of the terminal base material 30 and, at the same time, bending the pair of second rectangular plate portions 32 inward in the width direction in a stepwise manner. In the bending process, in order to prevent interference between the pair of second rectangular plate portions 32 forming the solid portion on the inner peripheral side of the electric connection portion 11 having a solid structure, an angle by which the distal end portion of the terminal base material 30 (the first rectangular plate portion 31 and the pair of second rectangular plate portions 32) is bent is decided in each process.

In the present embodiment, the bending process includes at least first to sixth bending processes for bending the pair of second rectangular plate portions 32 inward in the width direction in a stepwise manner.

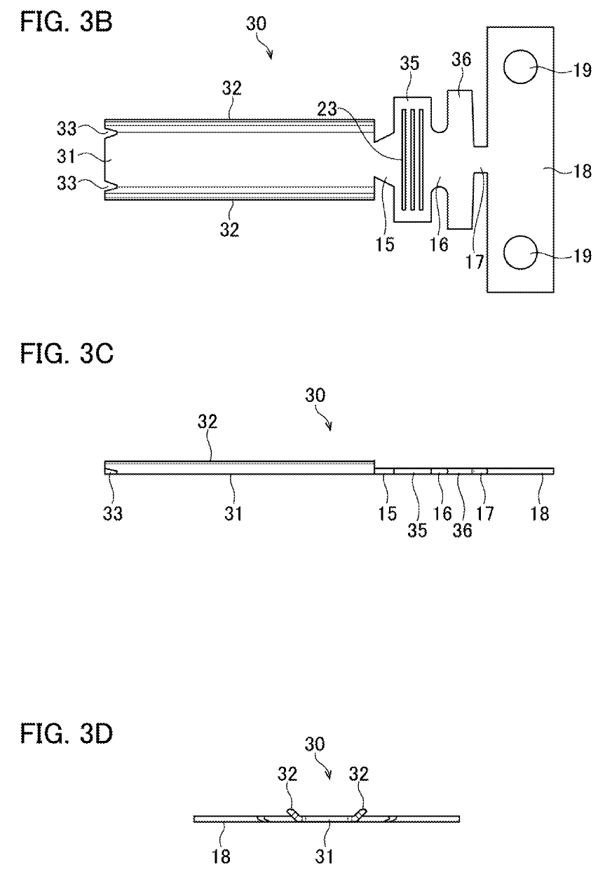

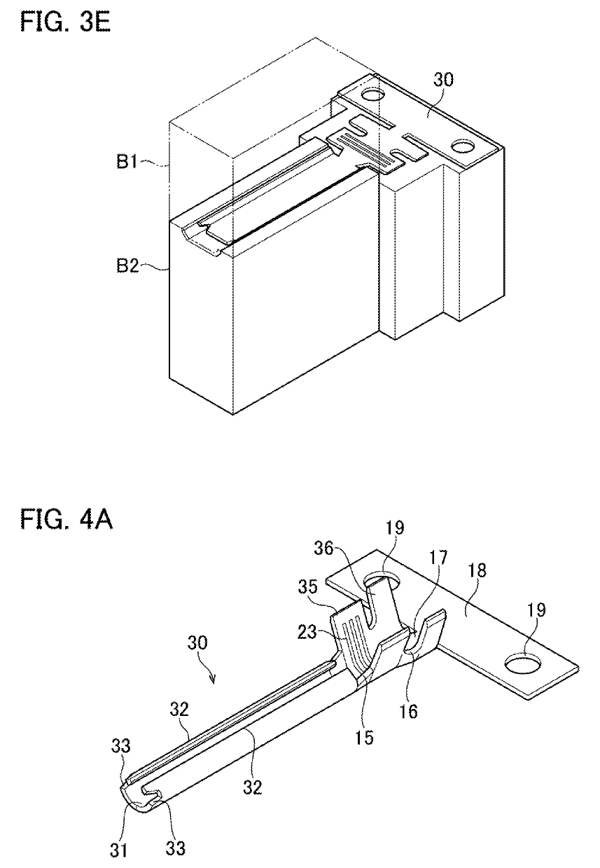

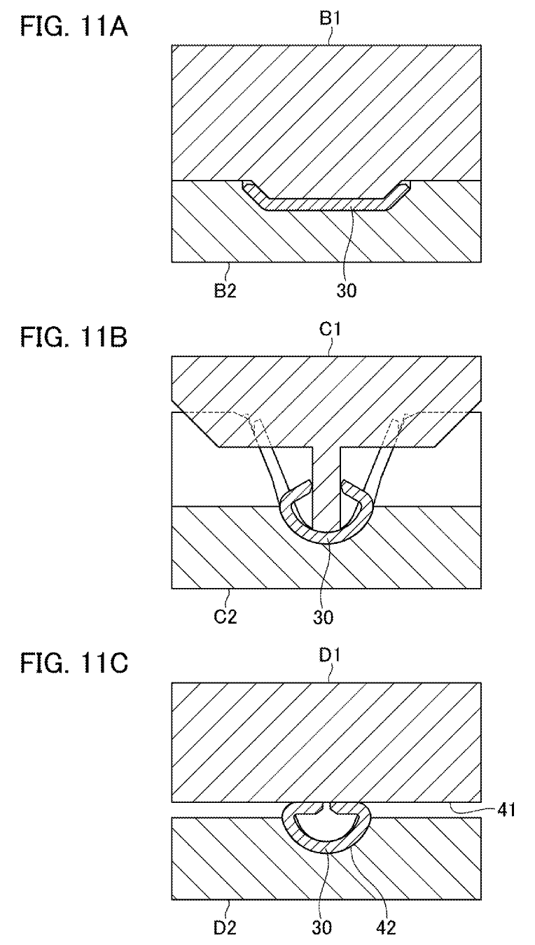

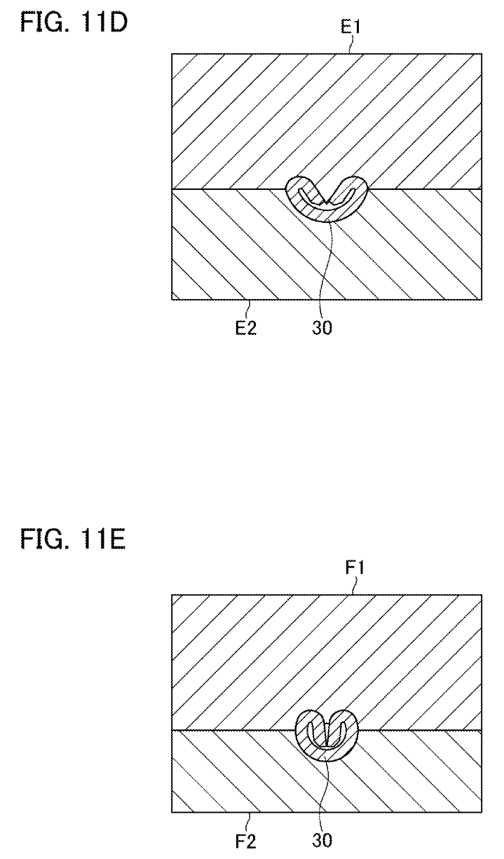

As illustrated in FIGS. 3A-3E, and 11A, in the first bending process, press-formation is performed using dies B1 and B2, and the pair of second rectangular plate portions 32 are bent inward in the width direction by approximately 45 degrees.

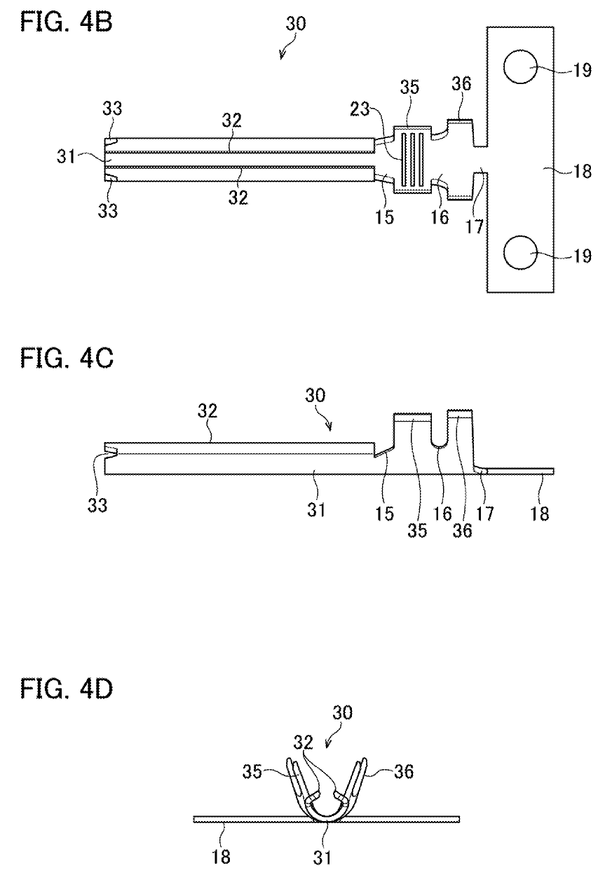

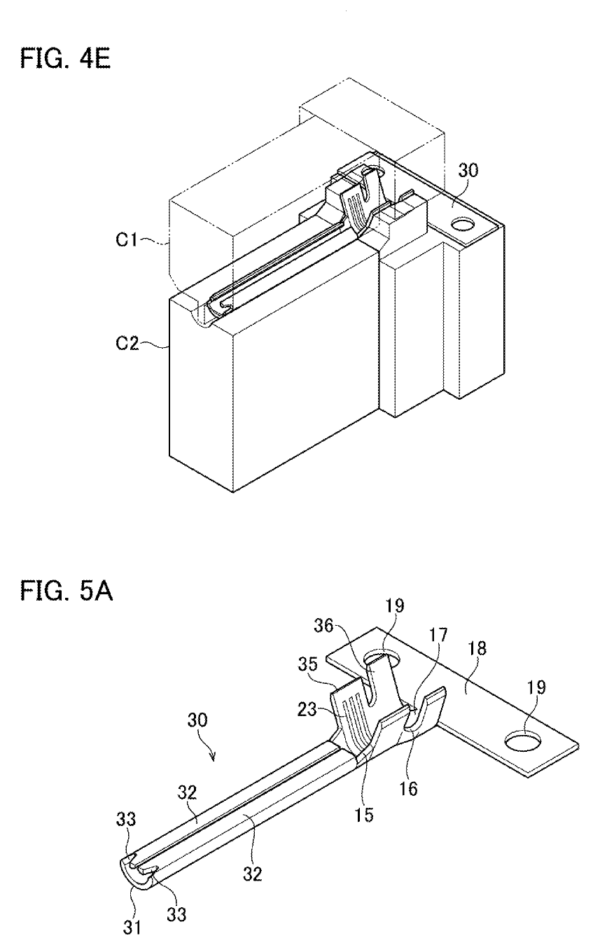

As illustrated in FIGS. 4A-4E, and 11B, in the second bending process, press-formation is performed using dies C1 and C2, and the first rectangular plate portion 31 is bent so as to protrude outward in the plate thickness direction of the terminal base material 30. With this, the pair of second rectangular plate portions 32 are positioned inward in the width direction.

Further, in the second bending process, press-formation may be performed using the dies B1 and B2, the third rectangular plate portion 35 and the fourth rectangular plate portion 36 may be bent so as to protrude outward in the plate thickness direction of the terminal base material 30, and thus the third rectangular plate portion 35 and the fourth rectangular plate portion 36 may be formed into a substantially U-shape.

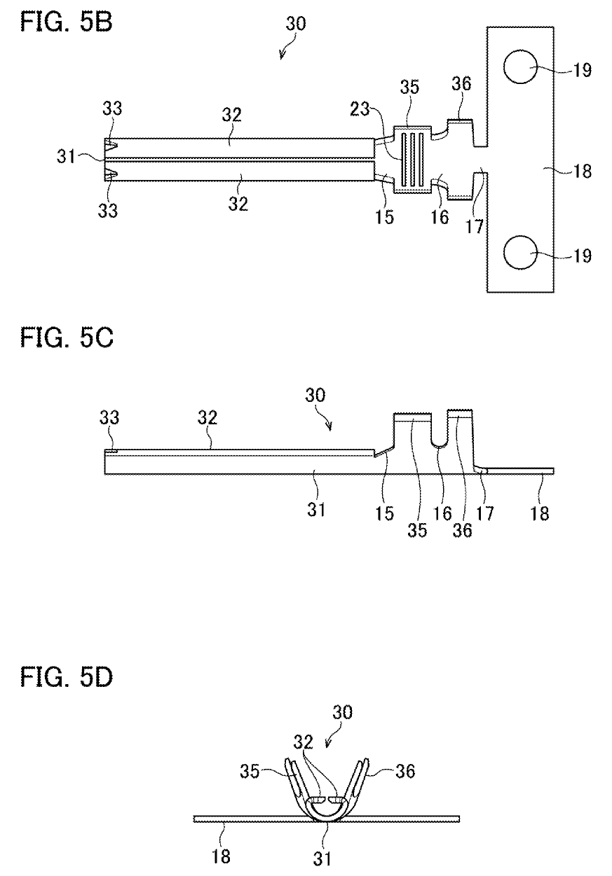

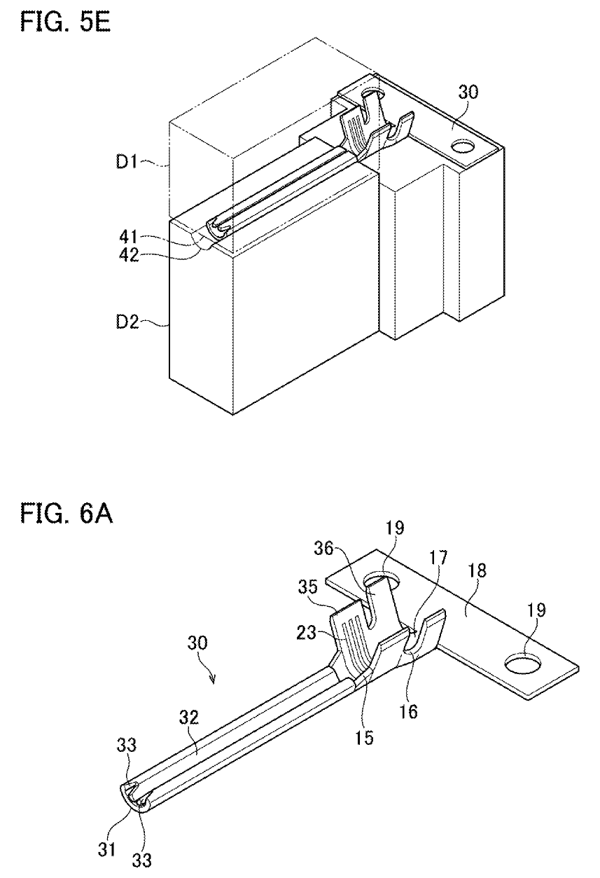

The bending process includes a process (the third bending process) of bending the second rectangular plate portion 32 along the width direction when the pair of second rectangular plate portions 32 is bent in a stepwise manner. As illustrated in FIGS. 5A-5E, and 11C, in the third bending process, press-formation is performed using dies D1 and D2, and the pair of second rectangular plate portions 32 are bent inward in the width direction by approximately 45 degrees.

In the third bending process of bending the second rectangular plate portion 32 along the width direction, press-formation is performed using the die D1, and a flat portion 41 is formed on a part of the die D1 that comes into contact with the second rectangular plate portion 32 (see FIGS. 5E and 11C). By forming the flat portion 41 on the part of the die D1 that comes into contact with the second rectangular plate portion 32, it is possible to reduce die cost as compared with a case where a recess portion or a projection portion is formed on the lower surface of the die D1. On the other hand, in the upper surface of the die D2, a recess portion 42 that holds the distal end portion of the terminal base material 30 (the first rectangular plate portion 31) is formed (see FIGS. 5E and 11C).

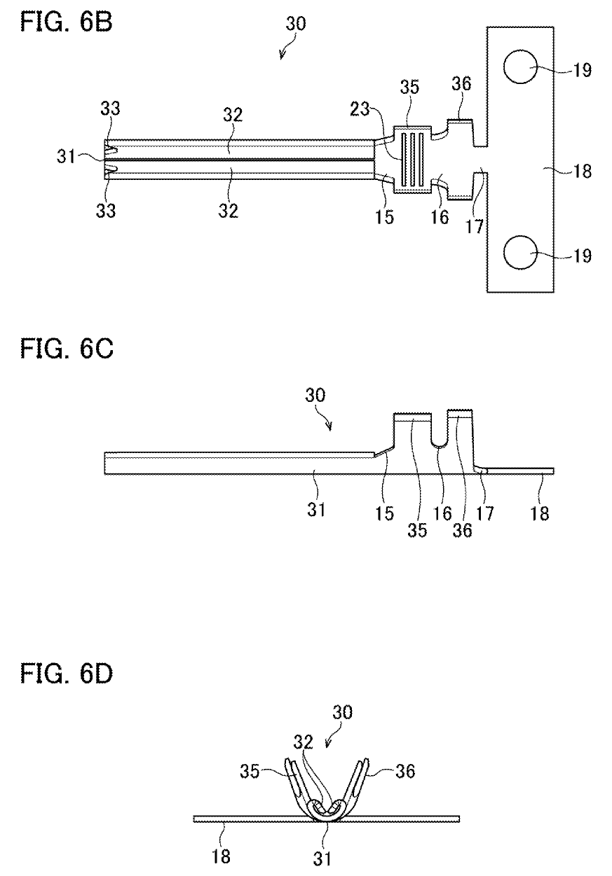

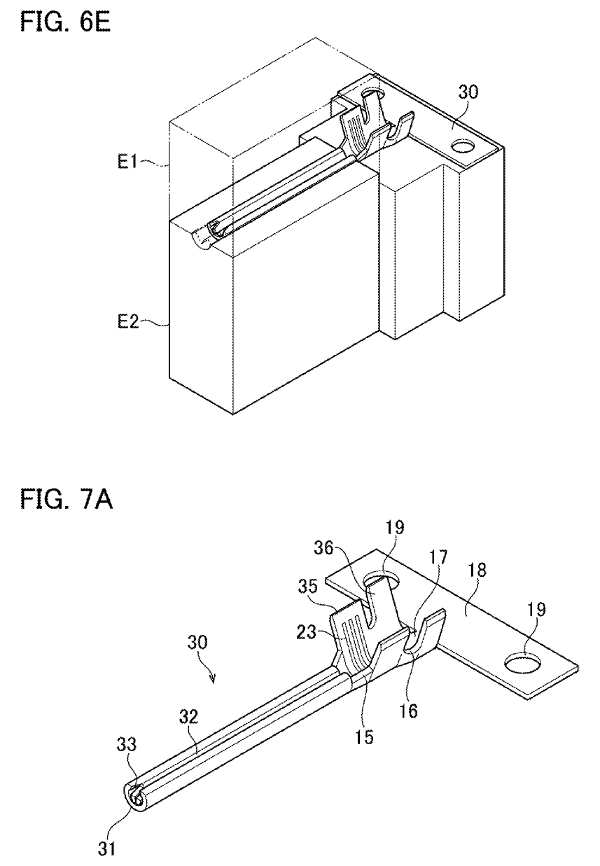

The bending process includes, between the third bending process and the fifth bending process, a process (the fourth bending process) of inserting at least a part of the second rectangular plate portion 32 bent along the width direction between both end portions of the first rectangular plate portion 31 in the width direction. As illustrated in FIGS. 6A-6E, and 11D, in the fourth bending process, press-formation is performed using dies E1 and E2, and at least a part of the pair of second rectangular plate portions 32 is inserted between both the end portions of the first rectangular plate portion 31 in the width direction.

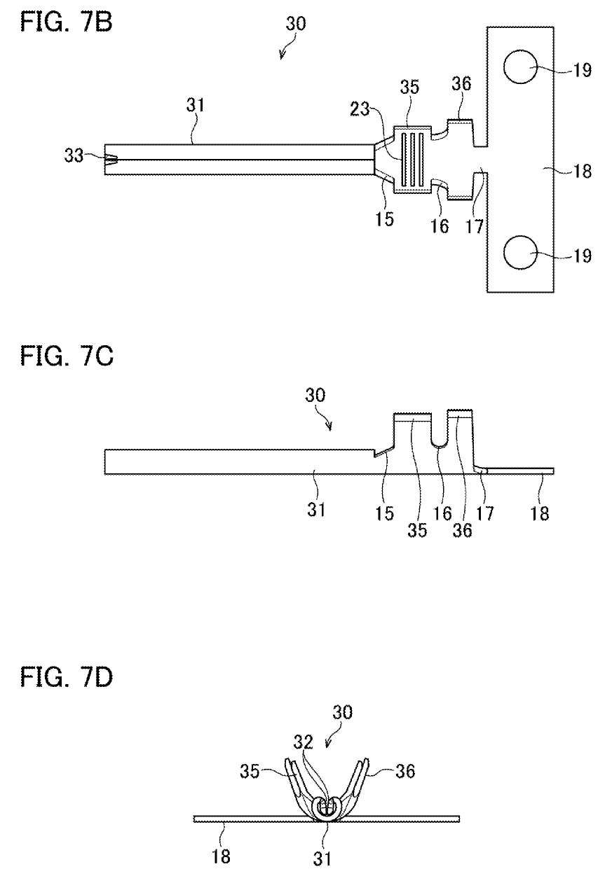

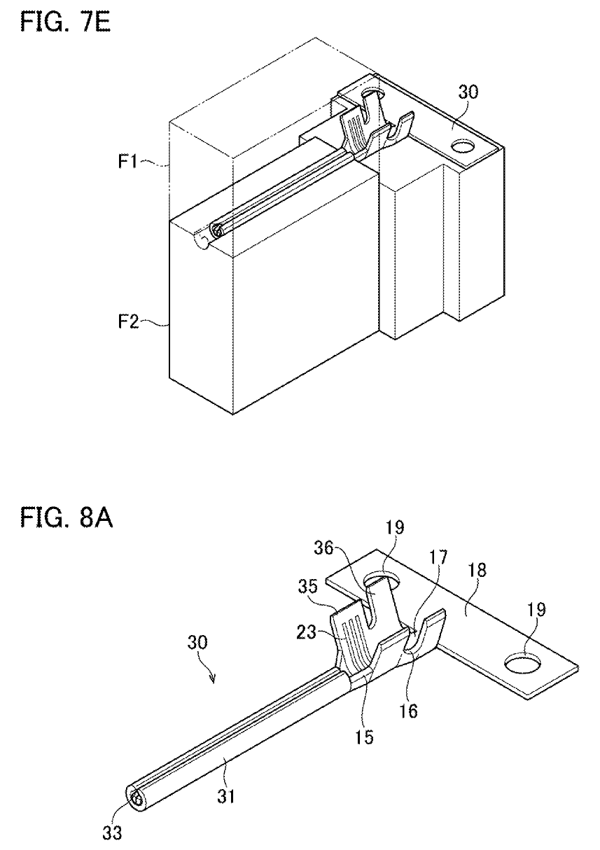

The bending process includes a process (the fifth bending process) of bending the first rectangular plate portion 31 so that both the end portions of the first rectangular plate portion 31 in the width direction approach each other. As illustrated in FIGS. 7A-7E, and 11E, in the fifth bending process, press-formation is performed using dies F1 and F2, the first rectangular plate portion 31 is bent so that both the end portions of the first rectangular plate portion 31 in the width direction approach each other.

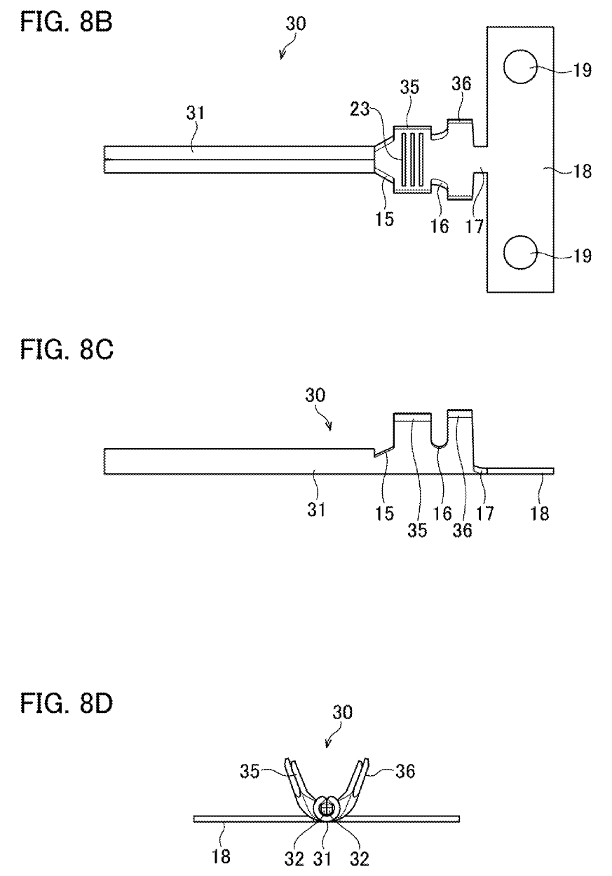

As illustrated in FIGS. 8A-8D, in the sixth bending process, press-formation is performed using a die (omitted in illustration), and the first rectangular plate portion 31 is further bent inward in the width direction so that both the end portions of the first rectangular plate portion 31 in the width direction approach each other more closely.

In the present embodiment, in the second to sixth bending processes, the first rectangular plate portion 31 forming the cylindrical outer shell portion on the outer peripheral side of the electric connection portion 11 having a solid structure and the pair of second rectangular plate portions 32 forming the solid portion on the inner periphery side thereof are subjected to press working at the same time. Further, the fourth bending process is additionally performed between the third bending process and the fifth bending process, and the first rectangular plate portion 31 and the pair of second rectangular plate portions 32 of the terminal base material 30 are bent in a stepwise manner. With this, a stress generated in the terminal base material 30 can be dispersed, and the shape accuracy of the electric connection portion 11 can be improved.

Next, with reference to FIGS. 9A-9D, the compression process is described.

The compression process is a process of compressing, in an intersecting direction (in the present embodiment, an up-down direction) intersecting with a front-rear direction, the pair of second rectangular plate portions 32 bent inward in the short-side direction and the first rectangular plate portion 31 to form the electric connection portion 11 having a solid structure. In the compression process, press-formation is performed using a die (omitted in illustration), the pair of second rectangular plate portions 32 and the first rectangular plate portion 31 are compressed in the up-down direction, and thus the electric connection portion 11 having a solid structure is formed.

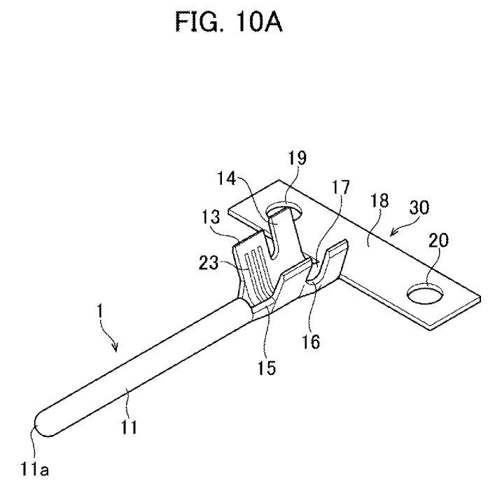

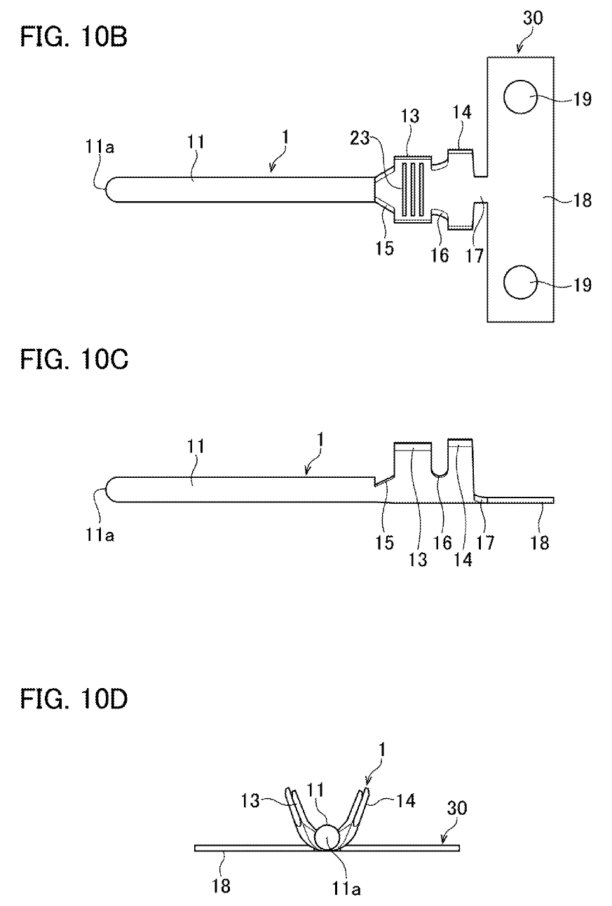

Next, with reference to FIGS. 10A-10D, the distal end shape forming process is described.

The distal end shape forming process is a process of forming the distal end portion 11a of the electric connection portion 11 having a solid shape into a hemispherical shape. In the distal end shape forming process, press-formation is performed using a die (omitted in illustration), and the distal end portion 11a of the electric connection portion 11 is formed into a hemispherical shape.

Then, the third joining portion 17 is cut, and the link portion 18 is separated away from the insulator crimping portion 14 of the terminal 1. With this, a solid terminal (the terminal 1) including the electric connection portion 11 having a solid structure can be obtained as illustrated in FIG. 1.

As described above, the method of manufacturing the terminal 1 according to an aspect of the present embodiment is a method of manufacturing the terminal 1 including the electric connection portion 11 having a solid structure to which the mating terminal is electrically connected. The method of manufacturing the terminal 1 includes the punching process of subjecting the metal plate material to punching to form the terminal base material 30 including the first rectangular plate portion 31 having a rectangular plate shape and the pair of second rectangular plate portions 32 each having a rectangular plate shape and being arranged on both the sides of the first rectangular plate portion 31 in the short-side direction (the width direction) thereof. The method of manufacturing the terminal 1 includes the bending process of bending the first rectangular plate portion 31 so as to protrude outward in the plate thickness direction of the terminal base material 30 and, at the same time, bending the pair of second rectangular plate portions 32 inward in the short-side direction (the width direction) in a stepwise manner. The method of manufacturing the terminal 1 includes the compression process of compressing, in the intersecting direction (the up-down direction) intersecting with the longitudinal direction (the front-rear direction), the pair of second rectangular plate portions 32 bent inward in the short-side direction (the width direction) and the first rectangular plate portion 31 to form the electric connection portion 11 having a solid structure. The method of manufacturing the terminal 1 includes the distal end shape forming process of forming the distal end portion 11a of the electric connection portion 11 having a solid structure into a hemispherical shape. The bending process includes at least the process (the third bending process) of bending the second rectangular plate portion 32 along the short-side direction (the width direction) while bending the pair of second rectangular plate portions 32 in a stepwise manner. The bending process includes at least the process (the fourth bending process) of inserting at least a part of the second rectangular plate portion 32 bent along the short-side direction (the width direction) between both the end portions of the first rectangular plate portion 31 in the short-side direction (the width direction). The bending process includes at least the process (the fifth bending process) of bending the first rectangular plate portion 31 so that both the end portions of the first rectangular plate portion 31 in the short-side direction (the width direction) approach each other.

In the present embodiment, the pair of second rectangular plate portions 32 forming the solid portion on the inner peripheral side of the electric connection portion 11 are formed on both the sides of the first rectangular plate portion 31, which forms the outer shell portion on the outer peripheral side of the electric connection portion 11, in the width direction. With this, the vertical width Wc of the terminal base material 30 can be smaller than that in the related art. In other words, the lateral width Wa of the first rectangular plate portion 31 is increased more than that in the related art within a range smaller than the lateral width Wb of the link portion 18 having a band plate shape, and consequently, the material yield of the terminal base material 30 can be improved. Thus, according to the present embodiment, the material yield of the terminal base material 30 can be improved to suppress an increase in material cost, and an increase in manufacturing cost due to an increase in material cost can be suppressed.

Further, in the present embodiment, the first rectangular plate portion 31 and the pair of second rectangular plate portions 32 of the terminal base material 30 are bent in a stepwise manner. With this, a stress generated in the terminal base material 30 can be dispersed, and the shape accuracy of the electric connection portion 11 can be improved. Thus, according to the present embodiment, the shape accuracy of the electric connection portion 11 can be improved, and the variation in the dimensions of the terminal 1 can be reduced.

Moreover, in the present embodiment, in the second to sixth bending processes, the first rectangular plate portion 31 forming the cylindrical outer shell portion on the outer peripheral side of the electric connection portion 11 having a solid structure and the pair of second rectangular plate portions 32 forming the solid portion on the inner peripheral side thereof are subjected to press working at the same time. Thus, the number of manufacturing processes can be reduced as compared with the related-art method, an increase in die cost can be suppressed, and an increase in manufacturing cost due to an increase in die cost can be suppressed.

As described above, according to the present embodiment, it is possible to provide the method of manufacturing the terminal 1 that achieves manufacturing cost reduction by improving yield and reducing the number of manufacturing processes.

In the method of manufacturing the terminal 1, in the bending the second rectangular plate portion 32 along the short-side direction (the width direction), press-formation may be performed using the forming die (the die D1). Further, the flat portion 41 may be formed on a part of the forming die (the die D1) that comes into contact with the second rectangular plate portion 32.

According to the present embodiment, by forming the flat portion 41 on the part of the die D1 that comes into contact with the second rectangular plate portion 32, it is possible to reduce die cost as compared with a case where a recess portion or a projection portion is formed on the lower surface of the die D1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A method of manufacturing a terminal including an electric connection portion having a solid structure to which a mating terminal is electrically connected, the method comprising:
a punching process of subjecting a metal plate material to punching to form a terminal base material including a first rectangular plate portion having a rectangular plate shape and a pair of second rectangular plate portions each having a rectangular plate shape and being arranged on both sides of the first rectangular plate portion in a short-side direction thereof;
a bending process of bending the first rectangular plate portion so as to protrude outward in a plate thickness direction of the terminal base material and, at the same time, bending the pair of second rectangular plate portions inward in the short-side direction in a stepwise manner;
a compression process of compressing, in an intersecting direction intersecting with a longitudinal direction, the pair of second rectangular plate portions bent inward in the short-side direction and the first rectangular plate portion to form the electric connection portion having a solid structure; and
a distal end shape forming process of forming a distal end portion of the electric connection portion having a solid structure into a hemispherical shape, wherein
the bending process includes at least:
a bending the second rectangular plate portion along the short-side direction while bending the pair of second rectangular plate portions in a stepwise manner;
a inserting at least a part of the second rectangular plate portion bent along the short-side direction between both end portions of the first rectangular plate portion in the short-side direction; and
a bending the first rectangular plate portion so that both the end portions of the first rectangular plate portion in the short-side direction approach each other.

2. The method of manufacturing a terminal according to claim 1, wherein
in the bending the second rectangular plate portion along the short-side direction, press formation is performed using a forming die, and a flat portion is formed on a part of the forming die that comes into contact with the second rectangular plate portion.
